(19) United States
(12) Patent Application Publication
(10) Pub. No.: US 2008/0174282 A1
(43) Pub. Date: Jul. 24, 2008

(54) Power supply device

(75) Inventors: Toshiyuki Kano, Musashino-shi (JP); Toshiyuki Iai, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/974,385

(22) Filed: Oct. 11, 2007

(30) Foreign Application Priority Data
Oct. 13, 2006 (JP) 2006-279773

(51) Int. Cl. H02J 7/00; H02P 9/06; F16K 15/00

(52) U.S. Cl. 322/35; 137/511; 320/101

(57) ABSTRACT

A power generator is connected with an air pipe through which compressed air is supplied to drive a valve arranged in a plant. The power generator generates power by utilization of the difference between the pressure of the compressed air and the atmospheric pressure. The power generator is used as a supply source of electricity to the battery or a power source to a wireless sensor. The battery is used as a power source for the wireless sensor.

This application claims priority to Japanese Patent Application No. 2006-279773, filed Oct. 13, 2006, in the Japanese Patent Office. The priority application is incorporated by reference in its entirety.

### TECHNICAL FIELD

The present disclosure relates to a power supply device for supplying electric power to field devices.

### RELATED ART

Sensors, using wireless technologies, are used as field devices arranged in a plant. With such sensors using wireless technologies, wires are not required in data transfer and hence wiring cost can be reduced significantly.

FIG. 4 shows a plant arrangement example using such sensors. A wireless sensor 1 using a battery as a power source communicates with a communication gateway 12 to transfer data.

Japanese Patent Unexamined Publication No. 2006-87291 describes a power generation system adapted to generate electric power from the compressed air stored.

In an environment where the periodical maintenance is performed once a several years such as in the plant, there is a difficulty in continuing the operation of the wireless sensor by only the battery for a period up to the next maintenance. Therefore, maintenance cost is increased. If wires for a power supply are laid, the merit of the use of wireless technologies is reduced. For these reasons, in order to prolong the battery exchange time, the power consumed amount is reduced, for example, by slowing down a communication cycle of gathering data or applying a sleep mode in a time other than data gathering. It is also a practice to reduce the distance between the sensor and a device with which the sensor communicates in order to reduce consumed power.

As mentioned above, in a wireless sensor using a battery as a power supply, data gathering is difficult to perform at a general communication cycle, and also there is a restriction for suppressing consumed power. Further, in the event of a battery failure or upon life-based battery exchange, data gathering cannot be performed. Particularly, in a case where the sensor consumes significant power, there is presently a difficulty in obtaining a practical wireless sensor.

### SUMMARY

Exemplary embodiments of the present invention provide a power supply device, which can reduce the maintenance cost, is freely from the restriction in an installation environment where a field device is used, and does not need the wiring cost of the power supply.

A power supply device for supplying electric power to a field device, according to one or more embodiments of the present invention, comprises: an air pipe; and a power generator that generates electric power under positive or negative pressure of a gas in the air pipe.

In the power supply device, power generation is made under the positive or negative pressure of a gas in the air pipe. Thus, the maintenance cost can be reduced, and the power supply device is freely from the restriction in an installation environment where the filed device is used and does not need the wiring cost of power supply.

The air pipe may be a pipe through which compressed air for controlling an opening degree of a valve is supplied.

The field device may be a wireless sensor.

The power supply device may further comprise a storage battery for supplying electric power to the field device, and the power generator may be used to charge the storage battery.

The power supply device may further comprise a pressure regulating unit provided between the air pipe and the power generator for regulating a pressure of a gas to be supplied to the power generator; and a control unit for performing feedback control to the pressure regulating unit in accordance with a power consuming status of the field device.

The power supply device may further comprise a pressure regulating unit provided between the air pipe and the power generator for regulating a pressure of a gas to be supplied to the power generator; and a control unit for performing feedback control to the pressure regulating unit in accordance with a charge status of the storage battery.

The power supply device may further comprise a monitor that monitors a pressure of a gas in the air pipe; and a cutoff valve that shuts off the power generator from the air pipe in accordance with a pressure being monitored by the monitor.

One or more embodiments of the present invention may include one or more the following advantages. For example, because power generation is made under the positive or negative pressure of a gas in the air pipe, the maintenance cost can be reduced, and the power supply device is freely from the restriction in an installation environment where the filed device is used and does not need the wiring cost of power supply.

Other features and advantages may be apparent from the following detailed description, the accompanying drawings and the claims.

### BRIEF DESCRIPTION OF THE DRAWINGS

FIG. 1A is a block diagram showing a configuration of a power supply device in an embodiment of the present invention.

FIG. 1B is a block diagram showing a configuration of a power supply device where a power generator is separated from a wireless sensor.

FIG. 1C is a block diagram showing a configuration of a power supply device where a power generator and a battery is separated from a wireless sensor.

FIG. 2A is a block diagram showing a configuration of a power supply device where a battery is omitted.

FIG. 2B is a block diagram showing a configuration of a power supply device where a power generator is separated from a wireless sensor.

FIG. 3A is a block diagram showing a configuration of a power supply device where the pressure of a compressed air supplied to a power generator is placed under feedback control.

FIG. 3B is a block diagram showing a configuration of a power supply device where a unit of suspending the use of compressed air is added to the structure as shown in FIG. 3A.

FIG. 4 is a block diagram showing a configuration of the related-art power supply device.

### DETAILED DESCRIPTION

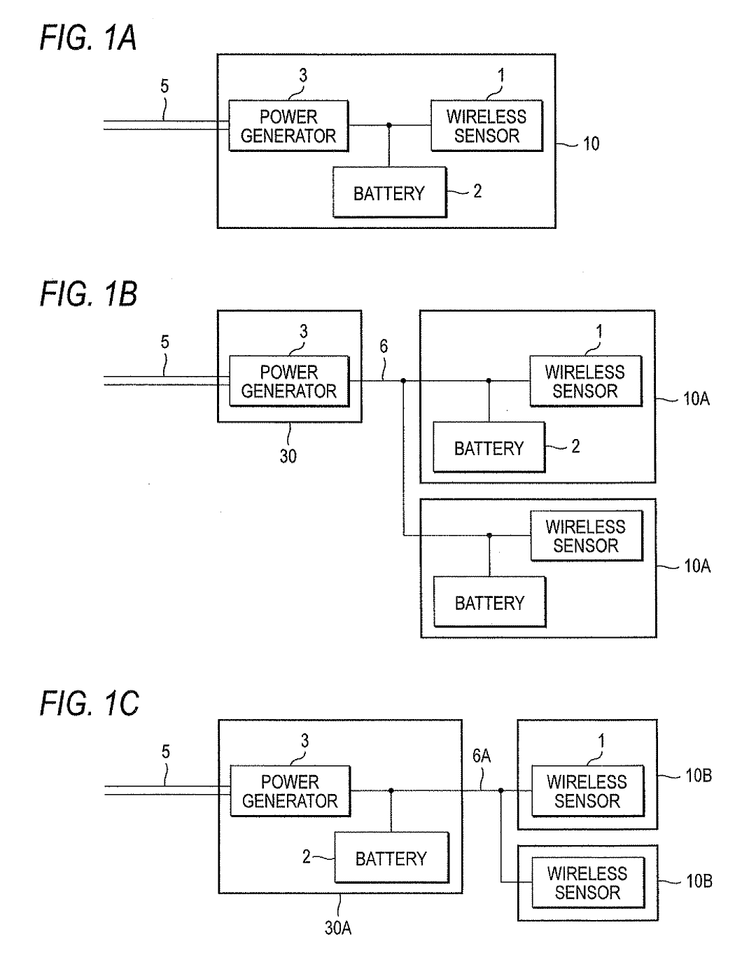

With reference to FIGS. 1A to 3B, embodiments of a power supply device according to the present invention will be explained.

FIG. 1A is a block diagram showing a configuration of a power supply device according to an embodiment of the present invention. As shown in FIG. 1A, the power supply device includes a wireless sensor 1 as a field device arranged in a plant, a battery 2 for supplying electric power to the wireless sensor 1, and a power generator 3. The wireless sensor 1, the battery 2 and the power generator 3 are accommodated in a common housing 10.

The wireless sensor 1 communicates with a communication gateway (not shown) so that it can periodically transfer the data acquired at the sensor to the communication gateway.

The power generator 3 is connected with an air pipe 5 through which compressed air for driving the valves arranged in the plant is supplied. The power generator 3 generates electric power by utilization of the difference between the pressure of compressed air and the atmospheric pressure. The power generator 3 is used as a supply source of electricity to the battery 2 or a power source for the wireless sensor 1. The battery 2 is used as a power source for the wireless sensor 1.

In the power supply device shown in FIG. 1A, by using compressed air as a supply source of power supply, a sensor significantly consuming power, for which the battery is impractically used as a power supply, can be provided as a wireless sensor. Further, because of no restrictions in consumed power, data can be gathered at a short cycle.

By using both the power generation based on the power generator 3 using compressed air and the battery 2 as a power source, at least the wireless sensor 1 is allowed to temporarily operate if either the power generator 3 or the battery 2 is normal. Consequently, in the event of a failure in any of the power sources or of exchanging the battery 2 or so, data gathering can be continued. Further, there is eliminated such operations as initial setting usually requested in the case of interrupted sensor operation.

FIG. 1B is a block diagram showing a configuration that a power generator is separated from a wireless sensor.

As shown in FIG. 1B, separated are a housing 30 receiving a power generator 3 connected with an air pipe 5 and a housing 10A receiving a wireless sensor 1 and a battery 2. The power generator 3, the wireless sensor 1 and the battery 2 are connected together through a power line 6.

According to the configuration as shown in FIG. 1B, the single power generator 3 can be used for a plurality of wireless sensors 1.

FIG. 1C is a block diagram showing a configuration that a battery is further arranged on the power generator side.

As shown in FIG. 1C, a housing 30A receives a power generator 3 connected with an air pipe 5 and a battery 2. The wireless sensor 1 received in the housing 10B is connected to the power generator 3 and battery 2, through a power line 6A.

According to the configuration as shown in FIG. 1C, the single power generator 3 and the single battery 2 can be used for a plurality of wireless sensors 1.

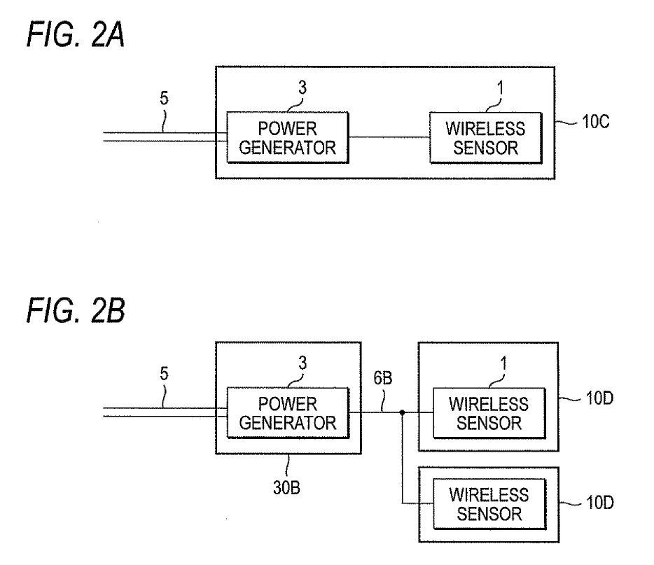

FIG. 2A is a block diagram omitted of the battery.

In the FIG. 2A case, a wireless sensor 1 uses a power generator 3 as a power source. The wireless sensor 1 and the power generator 3 are received in a common housing 10C.

FIG. 2B is a block diagram showing a configuration that the wireless sensor and the power generator are separated. A wireless sensor 1 is received in a housing 10D while a power generator 3 is in a housing 30B. The wireless sensor 1 and the power generator 3 are connected to each other by a power line 6B.

According to the configuration as shown in FIG. 2B, the single power generator 3 can be used for a plurality of wireless sensors 1.

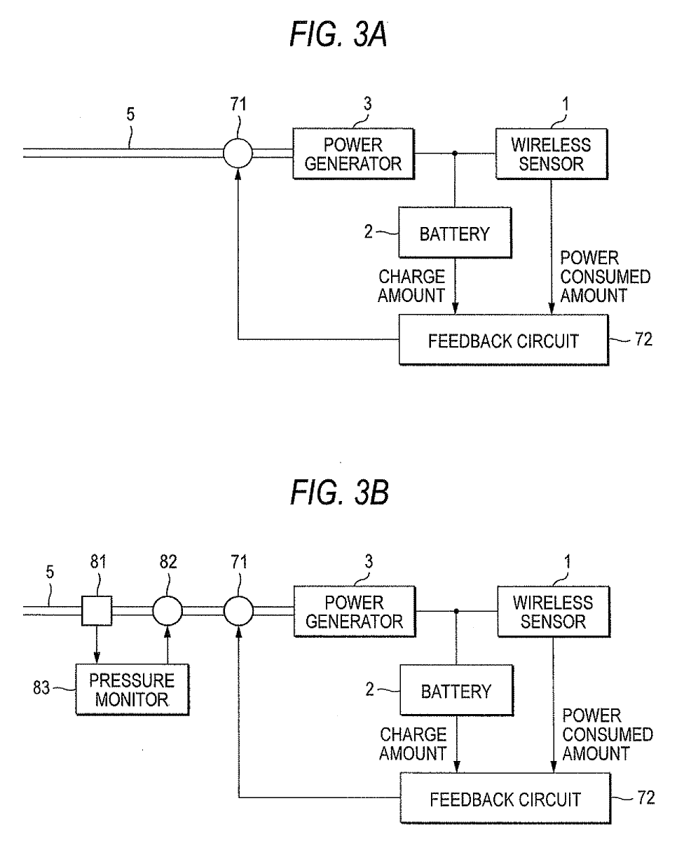

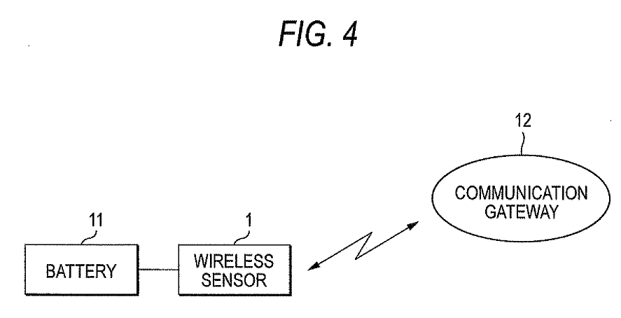

FIG. 3A shows a configuration that the pressure of a compressed air supplied to a power generator 3 is placed under feedback control.

As shown in FIG. 3A, a pressure regulation valve 71 is arranged on an air pipe 5. A feedback circuit 72 controls the opening of the pressure regulation valve 71 depending upon the power consumed amount by the wireless sensor 1 and the charge amount to a battery 2. By regulating the pressure of compressed air and suppressing the power generation at the power generator 3, compressed air can be avoided from used wastefully.

FIG. 3B shows a configuration that a unit of suspending the use of compressed air is added to the structure as shown in FIG. 3A.

As shown in FIG. 3B, a pressure sensor 81 for monitoring the pressure of compressed air and a cutoff valve 82 for shutting off a power generator 3 from the air pipe 5 are arranged on an air pipe 5. When the pressure sensor 81 detects a temporary increase of consumption of compressed air, a pressure monitor 83 closes the cutoff valve 82 depending upon the detection result thereof, to thereby suspend the power generator 3 from using compressed air. This can avoid the pressure of compressed air from lowering.

Although the embodiments uses compressed air for driving valves as a power source of power generation, another air pipe in plant can be used. The gas pressure in the air pipe may be positive or negative. For example, it is possible to use compressed air for cleaning blow, air-piping pressure (negative pressure) constituting a vacuum system, or the like.

As described so far, according to the power supply device of the present invention, power generation is made by utilization of the pressure of air in an air pipe arranged for the plant. Thus, wiring cost is not required, there is no restriction in an installation environment where a field device is used, and maintenance cost can be reduced.

The application scope of the present invention is not limited to the embodiments. The present invention is to be applied broadly for the power supply devices supplying electric power to field devices.

What is claimed is:

1. A power supply device for supplying electric power to a field device, the power supply device comprising:
an air pipe; and
a power generator that generates electric power under positive or negative pressure of a gas in the air pipe.

2. A power supply device according to claim 1, wherein the air pipe is a pipe through which compressed air for controlling an opening degree of a valve is supplied.

3. A power supply device according to claim 1, wherein the field device is a wireless sensor.

4. A power supply device according to claim 1, further comprising:
a storage battery for supplying electric power to the field device,
wherein the power generator is used to charge the storage battery.

5. A power supply device according to claim 1, further comprising:
a pressure regulating unit provided between the air pipe and the power generator for regulating a pressure of the gas to be supplied to the power generator; and
a control unit for performing feedback control to the pressure regulating unit in accordance with a power consuming status of the field device.

6. A power supply device according to claim 4, further comprising:
a pressure regulating unit provided between the air pipe and the power generator for regulating a pressure of the gas to be supplied to the power generator; and
a control unit for performing feedback control to the pressure regulating unit in accordance with a charge status of the storage battery.

7. A power supply device according to claim 1, further comprising:
a monitor that monitors a pressure of the gas in the air pipe; and
a cutoff valve that shuts off the power generator from the air pipe in accordance with the pressure being monitored by the monitor.
